(19) United States
(12) Patent Application Publication
(10) Pub. No.: US 2007/0058163 A1
(43) Pub. Date: Mar. 15, 2007

(54) Multi-point position measuring and recording system for anthropomorphic test devices

(75) Inventor: Daniel F. Handman, Boxboro, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Boxboro Systems LLC, Newton, MA (US)

(21) Appl. No.: 11/362,971

(22) Filed: Feb. 24, 2006

Related U.S. Application Data
(60) Provisional application No. 60/713,466, filed on Sep. 1, 2005.

(51) Int. Cl. G01C 17/00; G01B 11/26

(52) U.S. Cl. 356/152.1; 702/150

(57) ABSTRACT

The motion of an Anthropomorphic Test Device (ATD) member is measured. For example, the motion of ribs and other components of an ATD or Crash-Test Dummy are tracked during crash testing and dummy calibration using light angle detectors and triangulation techniques.

### RELATED APPLICATION

This application claims the benefit of U.S. Provisional Application No. 60/713,466, filed on Sep. 1, 2005. The entire teachings of the above application are incorporated herein by reference.

### BACKGROUND OF THE INVENTION

In general, car manufacturers have three different reasons to perform crash tests: (1) meeting US and European regulations in order to get the official approval and homologation for road service in the various countries; (2) meeting the requirements of various consumer tests such as EuroNCAP, US-NCAP, JNCAP etc.; and (3) research and development tests that give the design engineers valuable inputs to create safer cars. The National Highway Traffic Safety Administration (NHTSA) has a legislative mandate under Title 49 of the United States Code, Chapter 301, Motor Vehicle Standard, to issue Federal Motor Vehicle Safety Standards (FMVSS) and Regulations to which manufacturers of motor vehicles and items of motor vehicle equipment must conform and certify compliance. Part 572 defines the Anthropomorphic Test Devices.

Included in these regulations are definitions for the Hybrid III 50^{th} male, 5th female, 3-month-old, 9-month-old, 6-year-old, and 9-year-old frontal impact dummies, and a 50^{th} male side impact dummy. Several new frontal and side impact dummies are currently being reviewed world-wide for inclusion in enhanced safety standards. FMVSS 208 and 209 define testing methods for frontal impact tests, and FMVSS 214 defines methods for side impact crash tests. Similar standards exist throughout the world.

See Procedures for Assembly, Disassembly, and Inspection (PADI) of the Hybrid III 5^{th} Percentile Adult Female Crash Test Dummy (HIII-5F0, Alpha Version revised June 2002, National Highway Traffic Safety Administration (NHTSA reference), which is incorporated by reference in its entirety.

The regulations also define standards for impact protection based on a variety of force, acceleration, and displacement measurements taken on the dummies during a crash. Of particular importance is measurement of the deformation of the ribs of crash test dummies. FIG. 13 shows a side view of a Hybrid III 5^{th} female ATD, and FIGS. 14A and 14B show front and side views of the chest of the Hybrid III 5^{th} female, all taken from the Hybrid III NHTSA reference. The construction of this dummy is representative of the Hybrid III series.

The Hybrid III 5^{th} female ATD comprises a head assembly 1201, a neck assembly 1203, an upper neck bracket 1205, a lower neck bracket 1207, an upper rib guide 1209, an upper torso assembly 1211, a lower rib guide 1213, a lower torso assembly 1215, and a leg assembly 1217. FIGS. 14A and 14B provide a closer view of upper torso assembly 1211, which is where measurements of the deformation of the ribs are performed. Torso assembly 1211 comprises a rib set 1301 held in place with the use of behind rib straps 1303 and stiffener strip 1305, all contained within bib assembly 1307.

Currently, a potentiometer and linkage 1315 is used to measure the compression of the sternum 1311 towards the spine, or sternum stop 1309, at a single point in the middle of the sternum. Chest transducer assembly 1313 receives data from the potentiometer and linkage assembly 1315 and aids in the computation of chest deflection. One end of the linkage has a ball that rides in a track on the front of the sternum. Under severe impacts the ball disconnects from the track, invalidating the data collected. Automotive safety experts wish to get motion data from multiple points on the chest, and to extend the measurements from a single axis to two or three axes.

Alternatives to the chest potentiometer have been built and are currently being evaluated, including the “Thumper” which measures compression at 4 points on the chest, and a multipoint linkage system that measures three degrees of freedom at 4 points on the chest, such as the THOR Advanced Crash Test Dummy. They have not been incorporated into regulations at this time.

See THOR Advanced Crash Test Dummy User's Manual of the 50th Percentile Male (Alpha Version 1.1 released Dec. 14, 2001, National Highway Traffic Safety Administration reference), which is incorporated by reference in its entirety.

FIG. 1 shows a side view of a THOR (Test Device for Human Occupant Restraint) Alpha 50^{th} male version ATD, taken from the THOR Advanced Crash Test Dummy NHTSA reference. The ATD 100 comprises an instrumented head and face 101, a neck assembly 103, shoulder assembly 107, neck pitch change mechanism 109, adjustable posture spine assembly 111, pelvic assembly 113, femur assembly 115, instrumented abdominal assembles 119, and lower leg assembly 121. ATD 100 provides an estimate of bodily harm or deformation of the rib area of a human male with the use of elliptical ribs 105 and a four point chest deflection instrumentation 117.

A more detailed view of the elliptical ribs 105 and four point chest deflection instrumentation 117, may be seen in FIGS. 2A and 2B, taken from the THOR Advanced Crash Test Dummy NHTSA reference. Torso 117 comprises a rib assembly with rib stiffeners 201, a thoracic spine load cell 203, upper compact rotary units (CRUX) 205, lower CRUX units 207, a triaxial accelerometer 209, a sternal plate comprising a uniaxial accelerometer 211, an upper sternum 213, and a protective bib covering 215.

The triaxial accelerometer 209 is located in the center of gravity of torso 117 and is used to measure acceleration along three principle axes. The uniaxial accelerometer 211 is positioned on the sternal plate is and is used to measure acceleration at that point.

The upper and lower CRUX units, 205 and 207 respectively, measure the deflection of the rib cage and capture three dimension deformation data. The CRUX units comprise a two bar linkage system which features three measured degrees of freedom to provide a three-dimensional measurement. The CRUX unit comprises an end joint 224 with rotary capability, a mid joint 226 and a base joint 228. The mid joint 226 and base joint 228 further comprise precision rotary potentiometers 230 to measure the position of the various link-arms. A single potentiometer is mounted at the mid-joint and two potentiometers are mounted at the base joint. The CRUX unit is attached to the sternum bib through a bib attachment 222.

During impact testing, the output voltages from each of the three potentiometers are recorded with data acquisition systems. This data is processed to convert the output voltages into three-dimensional coordinates for X, Y, and Z displacement. Therefore the initial, dynamic and final positions of the unit may be determined directly from the potentiometer output voltage signals.

A tube lighting technique has also been developed where light emitting diodes and sensors are placed on opposite sides of an ATD rib connected by a telescoping tube. The telescoping tube will contract once the ribs are comprised. The light measured by the sensors will be increased in intensity once the ribs are comprised. A measurement of rib deformation may be achieved by measuring the intensity changes of the light.

All of the systems discussed above comprise mechanical assemblies that connect between the thoracic spine and the measurement points on the ribs or sternum plate.

### SUMMARY OF THE INVENTION

Due to the mass of the parts and friction in the assemblies, the measurement systems mentioned above affect the bio-fidelity, the measure of how well the ATD simulates a human being, of the chest assembly. All of the above mentioned ATD methods require mechanical connections between the measurement point and a reference point, thus reducing bio-fidelity as well as limiting the number of possible measurement points. Non-contact solutions are preferred in order to substantially increase the number of potential measurement points without affecting the bio-fidelity of the crash test dummy.

An ATD comprising a light emitter, the light emitter being mounted on an ATD member, and plural incident light detectors that receive light from the light emitter, is described. It should be appreciated that angle light detectors may be used as incident light detectors. The ATD measurement system will be described using a rib as an example of an ATD member. It should be appreciated that other components of the ATD may be measured for deformation. Preferably, no mechanical connections exist between the light emitter and the plural incident light angle detectors other than through the ATD member, thus increasing the bio-fidelity of the ATD.

Data is collected from the incident light angle detectors provides a measurement of ATD member deformation, wherein the measurement of the ATD deformation is performed with the use of optical triangulation techniques. Narrow band filters may be used on the light emitter and the plural incident light angle detectors in order to increase the number of measurement points while reducing cross-talk of neighboring measurement systems.

A method of providing an ATD measurement is also discussed. The method comprises steps of providing a light emitter, the light emitter being mounted on an ATD member, receiving light from the light emitter with the use of plural incident light angle detectors, collecting data from the incident light angle detectors, and providing a measurement of ATD member deflection. The method further comprises steps of calculating ATD member deflection with the use of optical triangulation techniques and preventing cross-talk of near-by measurement systems with the use of narrow band color filters.

A method of providing an ATD system is discussed. The method comprises steps of digitizing and storing, in memory, an output of at least one sensor in the ATD, and turning on, sequentially, only one of the plurality of light emitters while repeating the above step for a duration of a test. The method further comprises steps of downloading data samples stored in memory over a communication channel to an external computer, once the test is completed, and storing the data samples in a data file used in a calculation of ATD member deformation with the use of data visualization and analysis programs.

A third method of providing an ATD measurement is discussed. The method comprises a lighting means for providing a light emitter, the light emitter being mounted on an ATD member, a receiving means for receiving light from the light emitter, a collecting means for collecting data from plural incident light angle detectors, and a measurement means for proving a measurement of ATD member deflection. The method further comprises a filtering means for preventing cross-talk of near-by measurement systems.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of an ATD, according to the prior art;

FIG. 2A is a drawing of the torso of an ATD and FIG. 2B is a detailed drawing of an ATD CRUX unit;

FIG. 4 is a top view schematic depicting the position of the various components of the ATD measurement system;

FIG. 5 is a side view diagram depicting the position of the various components of the ATD measurement system;

FIG. 6 is a schematic depicting the use of triangulation with incident light angle detectors;

FIG. 7 is a schematic depicting triangulation with PSDs;

FIG. 8 is a drawing depicting three-dimensional detection with two pairs of sensors;

FIG. 9 is a schematic depicting triangulation with an area PSD and pinhole lens;

FIG. 10 is a top view schematic depicting the range of measurement of a pair of incident angle detectors;

FIG. 11 is a side view diagram depicting the range of measurement;

FIG. 12 is a block diagram of the ATD measurement system;

FIG. 13 a schematic of an ATD, according to the prior art; and

FIGS. 14A and 14B are front and side views, respectively, of the ATD torso assembly featured in FIG. 13.

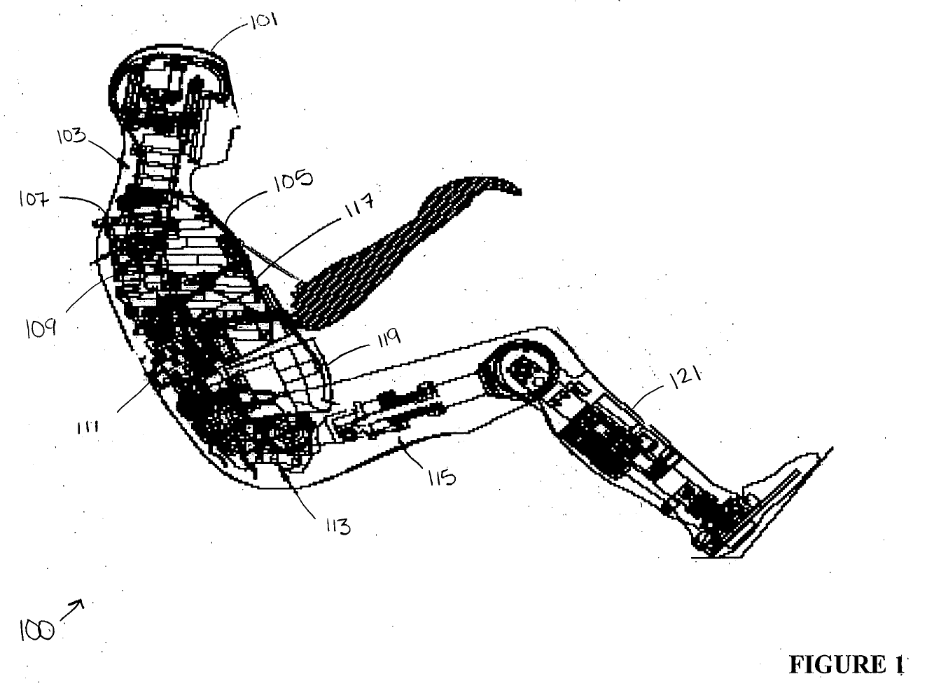

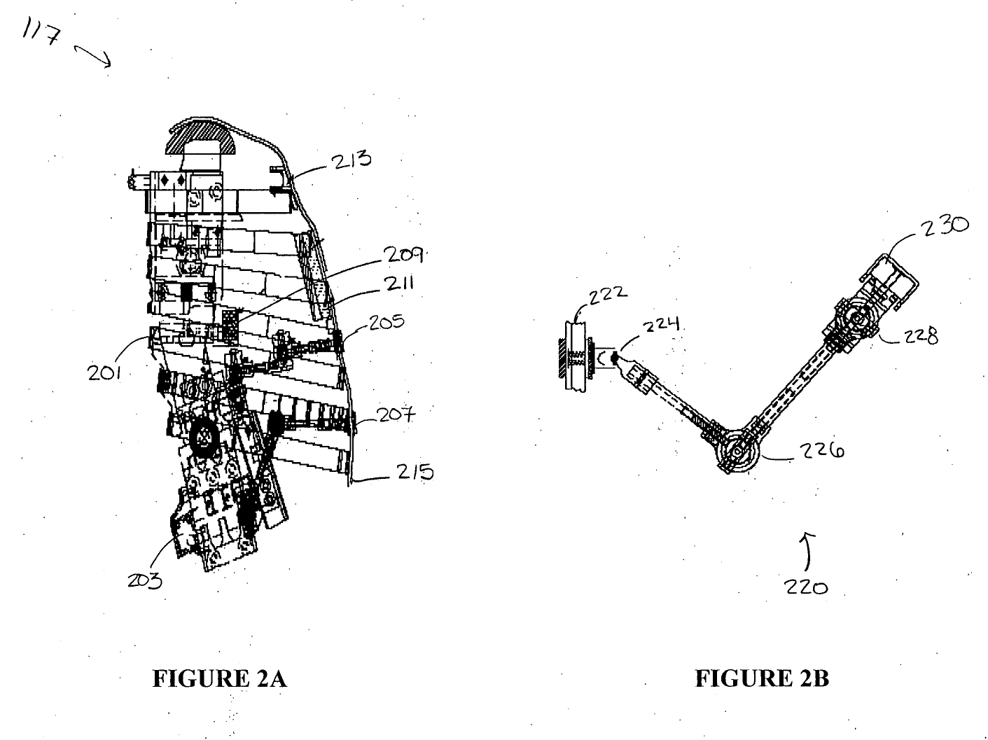

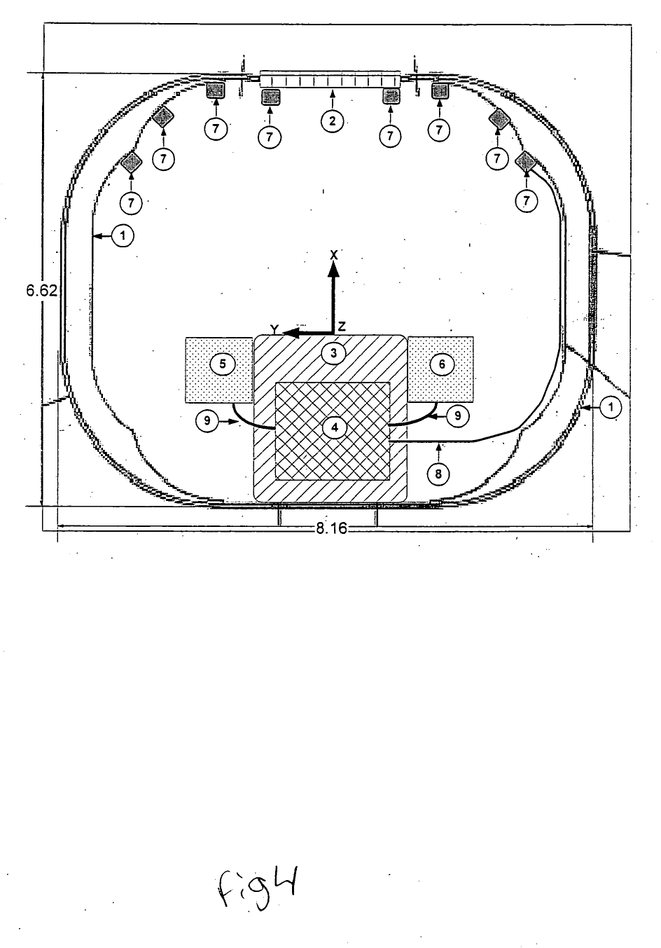

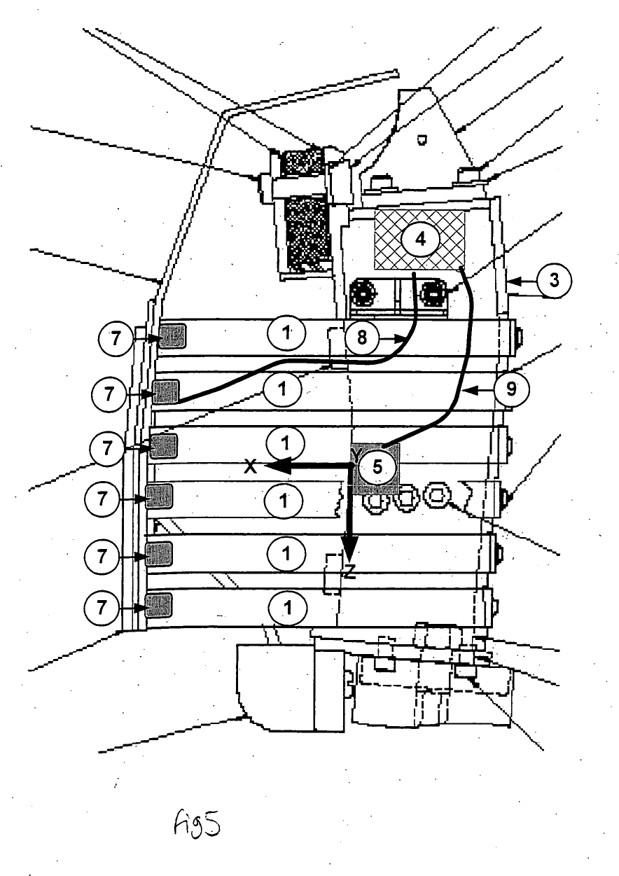

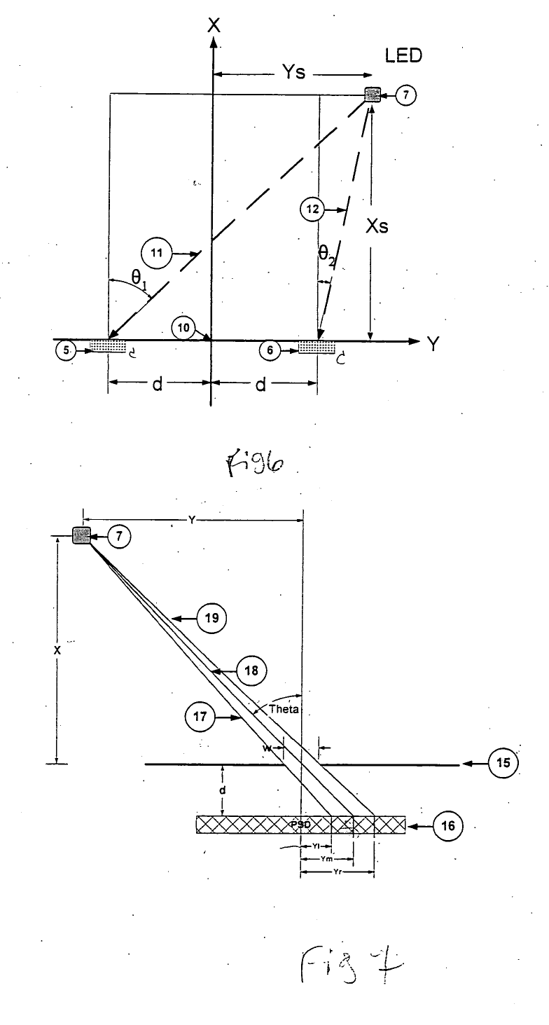

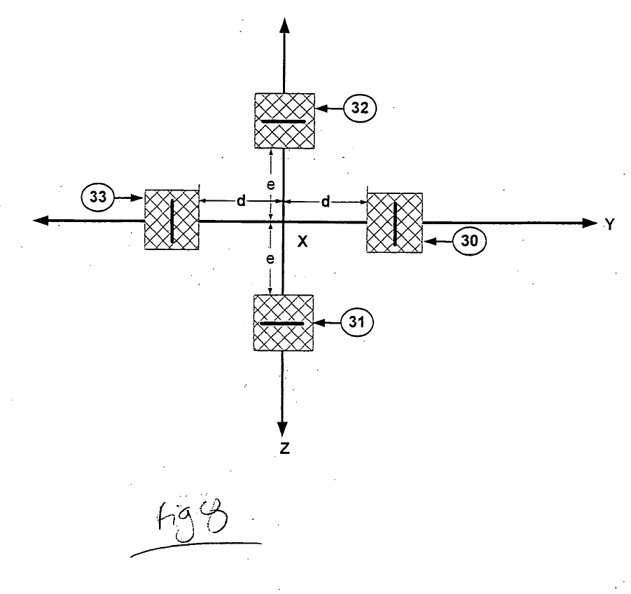

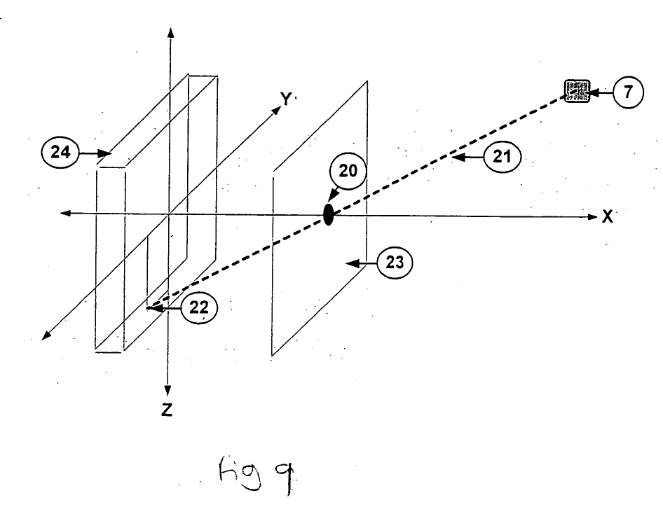

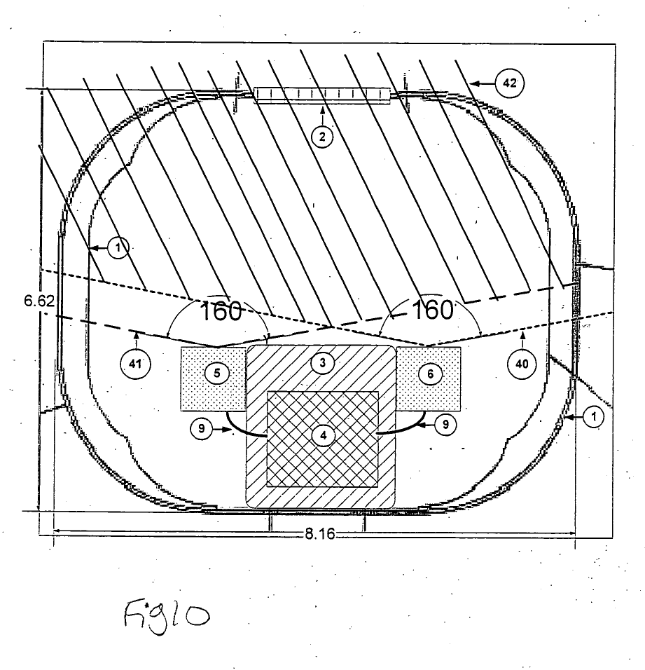

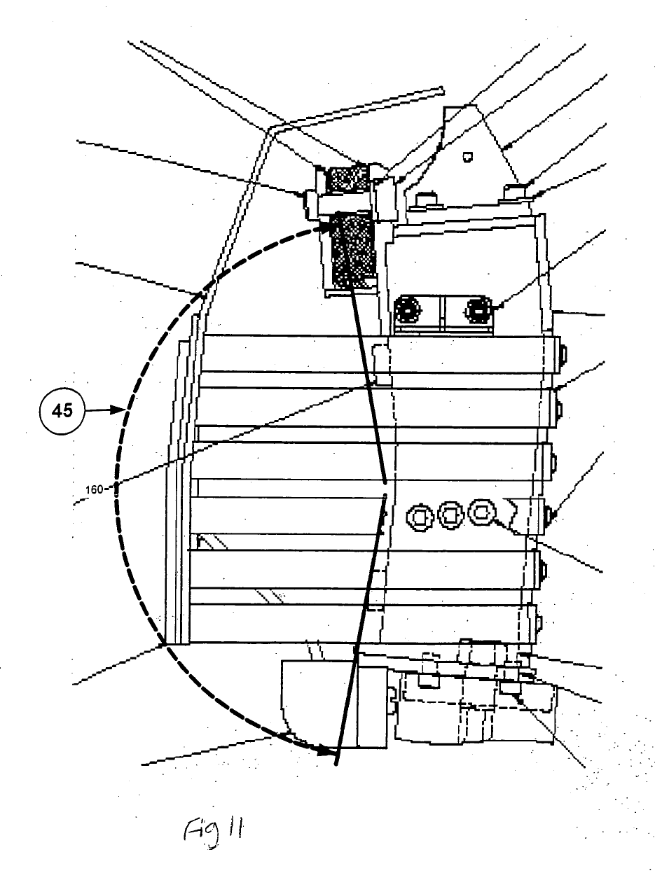

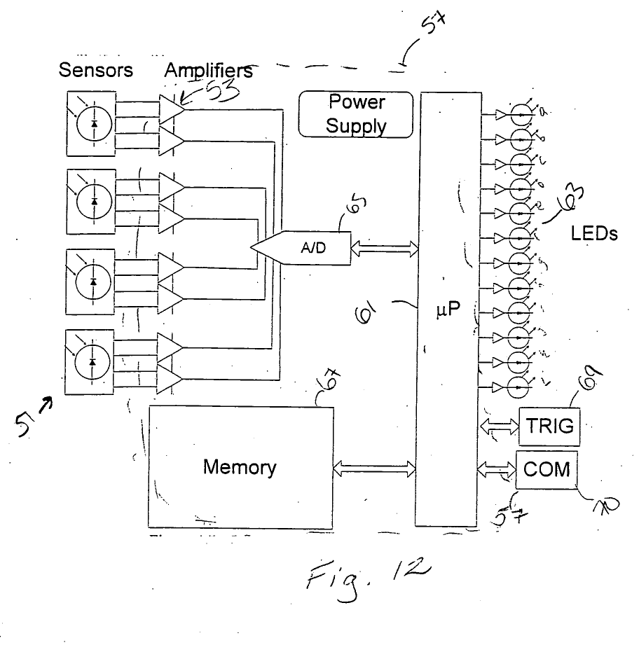

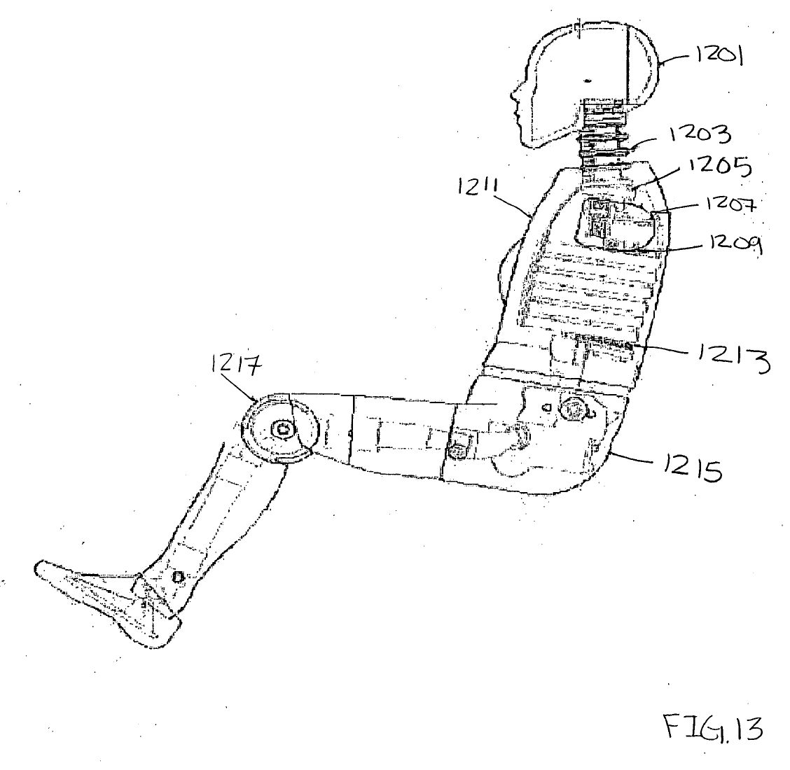

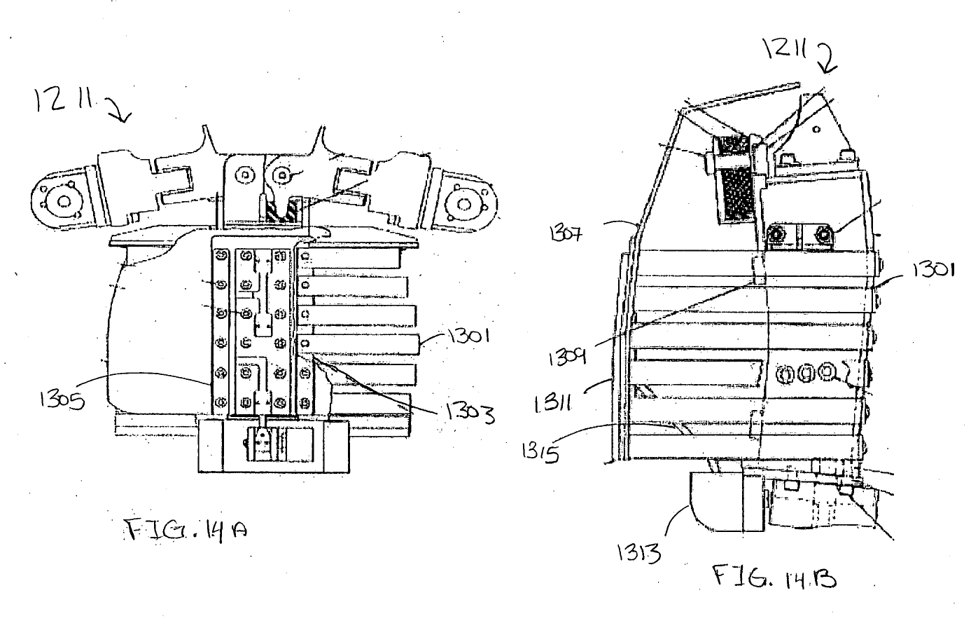

### DETAILED DESCRIPTION OF THE INVENTION

A description of preferred embodiments of the invention follows.

Optical triangulation techniques are used to monitor three-dimensional position data of multiple points on ATD ribs at high speeds suitable for crash test data. It comprises light emitting diodes (LEDs) placed at the desired measurement points, incident light angle detectors mounted to the thoracic spine, and a master controller placed inside the thoracic spine or a remote location.

The general arrangement of these components is shown in top and side views in FIGS. 4 and 5. (FIGS. 4 and 10 are taken from NHTSA Drawing Number 880105-361-xx. part of NHTSA Technical Drawings and Specifications P/N 880105, released Jun. 10, 2002, with overlays, and FIGS. 5 and 11 are taken from the NHTSA reference, with overlays.) The deflection measurement system comprises light emitting diodes 7 which are attached to the ribs 1 or sternum plate 2 at any location desired by the user. LEDs are very low in mass and therefore do not affect the bio-fidelity of the ribs or other components they are attached to. LEDs may be attached using nylon zip-ties or by any other attachment means. Several examples of possible LED locations are shown in FIG. 4. The LEDs are connected via a cable 8 to the controller/Data Acquisition System (DAS) 4 mounted within the thoracic spine assembly 3. Only one cable has been illustrated for clarity, it should be appreciated any number of cables may be implemented. Incident light angle sensors 5 and 6 are mounted on the left and right sides of the thoracic spine assembly to detect light from the various LEDs 7. The incident light angle sensors are connected via cables 9 to the controller/DAS. For typical testing, two LEDs will be mounted on each rib, spaced on either side (left and right) of the sternum plate. A total of 12 LEDs are used. It should be appreciated that multiple LEDs may be mounted on a rib, and/or dispersed among all of the ribs.

The LEDs are turned on one at a time, while two or more incident light angle detectors detect the angle of the LED with respect to the X-Y and X-Z planes. The method of monitoring motion in the X-Y plane will first be explained, and then an explanation of the measurement of LEDs located in the Z plane will follow. The coordinate systems refer to those marked in FIGS. 4 and 5.

FIG. 6 shows two incident light angle detectors 5 and 6 located a distance d from the origin in the +Y and −Y directions. An LED 7 is located at coordinates Xs and Y_{S} relative to origin 10. The LED emits light in many directions. Light rays 11 and 12 hit the centers of the incident light angle detectors making angles θ₁ and θ₂ with respect to the primary axis of the incident light angle detectors 5 and 6, in the X-Y plane. By measuring θ₁ and θ₂ we can calculate the tangents of the angles to derive k1 and k2, and therefore calculate the X_{S} and Y_{S} positions. The following equations may be used to determine the position of LED 7 in the X and Y coordinate:

$${k}_{1} = tan ( {θ}_{1} ) = \frac{( {Y}_{S} + d )}{{X}_{S}}$$

$${k}_{2} = tan ( {θ}_{2} ) = \frac{( {Y}_{S} - d )}{{X}_{S}}$$

$${X}_{S} = \frac{2 d}{( {k}_{1} + {k}_{2} )}$$

$${Y}_{S} = \frac{d ( {k}_{2} + {k}_{2} )}{( {k}_{1} - {k}_{2} )}$$

The preferred triangulation technique described above is based on the use of a light angle detectors. The triangulation approach might also be based on distance detectors. However, the signal of distance sensors falls off with the inverse of distance squared and such measurements are more sensitive to ambient light levels. A triangulation approach might also be based on plural emitters, at the locations at sensors 5 and 6, and a sensor at each rib location. The triangulation approach, used with wide beams from the LEDs, assures that the beams are detected by the sensors and that measurements are obtained even with a large displacement and/or twisting of the ribs.

Incident light angle detectors may be made using several technologies including position sensitive diodes (PSD), charge coupled devices (CCD), or dual photodiodes, with appropriate optics. PSDs are the preferred detectors since they provide the speed and resolution which are of importance for this application. A PSD is a linear or two-dimensional array of photosensitive material, that provides an output which is a function of the center of gravity of the total light quantity distribution of an its active area. For monitoring the LED position in a single plane, a linear PSD may be used. A linear PSD has two current outputs. When an area of the PSD is illuminated, two currents will be generated. The currents are proportional to the location of the center of gravity of the light spot with respect to the center of the PSD. The position of the center of gravity of the light spot, YM, can be calculated from the two output currents by:

$${Y}_{M} = ( \frac{L}{2} ) \frac{( {i}_{1} - {i}_{2} )}{( {i}_{1} + {i}_{2} )}$$

Where Y_{M} is the distance of the center of gravity of the light spot from the center of the PSD, L is the length of the PSD, i₁ is the current from terminal 1, and i₂ is the current from terminal 2.

FIG. 7 shows a PSD 16 placed a distance d behind a precision slit plate 15 with a slit width w. A LED light source 7 is located at coordinates (X, Y) with respect to the center of the slit. Three light rays are shown, 17, 18, and 19. Ray 17 passes by the left edge of the slit, ray 18 passes through the center of the slit, and ray 19 passes by the right edge of the slit. These rays define the illuminated length of the PSD, from Y_{L} to Y_{R}. If the rays are of the same intensity, the center of gravity of the illuminated area is given by Y_{M}. The slope of the line hitting the left edge of slit 15 may be given as:

$${m}_{L} = \frac{Δ Y}{Δ X} = \frac{( Y - \frac{w}{2} )}{X}$$

Therefore Y_{L}, the distance from the center of the PSD to the left edge of the illuminated area on the PSD, is given by:

$${Y}_{L} = \frac{d ( Y - \frac{w}{2} )}{X} - \frac{w}{2}$$

Likewise, the slope of the line hitting the right edge of the slit and the distance from the center of the PSD to the right edge of the illuminated area on the PSD may be given by:

$${m}_{R} = \frac{( Y + \frac{w}{2} )}{X}$$

$${Y}_{R} = \frac{d ( Y + \frac{w}{2} )}{X} + \frac{w}{2}$$

Finally, the center of gravity of the light spot from the center of the PSD may be given by:

$${Y}_{M} = \frac{( {Y}_{L} + {Y}_{R} )}{2} = \frac{Δ Y}{X}$$

$$X = r cos θ$$

$$Y = r sin θ$$

$${Y}_{M} = d ( \frac{sin θ}{cos θ} ) = d tan θ$$

It should be appreciated that making the slit width w small assures that the rays from a LED will all be of the same intensity. It should also be appreciated that Ym is proportional to the tangent of the angle θ, and the tangent of θ is used in the triangulation calculations given in above in the discussion of FIG. 6. The total PSD current is equal to the sum of i1 and i2, which is proportional to the light power incident on the PSD. Although a slit is shown as the optical element in FIG. 7, a cylindrical lens can also be used.

With either a slit or cylindrical lens, the configuration in FIG. 7 provides the incident light angle within the X-Y plane, and is insensitive to the LED orientation in the Z direction (in and out of the page in FIG. 7). The slit or cylindrical lens allows light rays from LEDs displaced in the Z direction for the X-Y plane of the sensor to hit the sensor, allowing the angle of the LED with respect to the X-Y plane to be measured.

This concept can be extended to monitoring the three-dimensional position of the LED in several ways. One method of providing a three-dimensional measurement is to add a second pair of sensors aligned to measure the incident light angle with respect to the X-Z plane, as shown in FIG. 8. In FIG. 8, incident angle sensors 30 and 33 are spaced a distance d from the origin along the Y axis. This sensor pair provides the incident light angle with respect to the X-Y plane. A second pair of incident light angle sensors 31 and 32 are displaced a distance e from the origin along the Z axis, and provide the incident light angle with respect to the X-Z plane. Using the same equations as described previously, the LED X and Y positions may be calculated from sensor pair 30, 33. The X and Z positions may be calculated from sensor pair 31,32. This topology has the advantage of providing redundant information for the X coordinate, the most critical dimension in terms of torso injury assessment.

A second approach to getting three-dimensional information is to use an area-type PSD. Area PSDs have four outputs, arranged in two pairs of two. One pair provides displacement data for the Y axis, and the second pair provides data for the Z axis. Instead of a slit or cylindrical lens used in the 2-dimensional case, a pinhole or round lens is used.

FIG. 9 shows an area PSD 24 with a plate 23 with a pinhole lens 20 mounted in front of PSD 24. Light rays 21 from the LED 7 pass through the pinhole and illuminate a spot 22 on the area PSD. The Y and Z locations of the center of gravity of the spot are read from the area PSD by monitoring the four current outputs and processing each pair of current outputs in a similar fashion as described above for the two-dimensional case.

The range of measurement for this system, for either the two-dimensional or the three-dimensional case, depends on the field of view of each of the incident light angle sensors. When a pair of sensors is used, the measurement range is defined as where the fields of view of the two sensors overlap. FIG. 10 shows a top view of the ATD chest with a pair of incident light angle sensors 5,6. Each sensor has a 160 degree field of view. The field of view of sensor 5 is shown as dashed lines 41, while the field of view of sensor 6 is shown as dotted line 40. The overlapping range of the two field of views is shown by angled lines 42. In the three-dimension case, the measurement range is defined by a cone with a solid angle equivalent to the field of view of the sensors. FIG. 11 shows the three-dimensional measurement range 45 from a side view of the dummy.

FIG. 12 shows a block diagram of the electrical circuitry for the system. Sensors 51 comprise PSDs configured as incident light angle detectors combined with the signal conditioning transimpedance amplifiers 53. The amplified and conditioned outputs of the sensor heads are high level signals that are connected via cables to the controller/DAS unit 57. The controller/DAS unit 57 controls the timing and drive current of the LEDs. The controller/DAS unit 57 is also used for digitizing and recording the outputs of the sensors.

The microprocessor 61 and its firmware control the recording process as follows. With all LEDs 63a-1 turned off, the microprocessor 61 triggers the A/D converter 65, and stores the digitized output of each sensor in memory 67. This provides a measure of the ambient light. Next the microprocessor 61 turns on the first LED 63a, triggers the A/D 65, and stores all of the digitized sensor data in memory 67. The first LED 63a is turned off, and the next LED 63b is turned on, and the process is repeated until all LEDs 63a-1 have been energized and the sensor readings recorded. The process is repeated continuously until the test is completed.

For crash testing applications, data is typically acquired for each LED 10,000 times per second, or 100 microseconds between each reading. If 12 LED positions are to be monitored, as well as one sample with all LEDs off, at a 10 kHz sample rate, we divide each 100 microsecond sample period into 13 even increments. Each LED will be turned on for 100/13=7.6 microseconds. During the 7.6 microsecond time period all of the incident light angle sensor outputs will be digitized and the results stored in memory.

After the test is completed, all of the data samples stored in memory are processed, in order to convert raw sensor readings to LED positions in engineering units, as follows: For each data sample, the LED-off samples are subtracted from the LED-on samples to compensate for ambient light. The ambient light corrected data is then adjusted using calibration curves for the sensor heads and then this data is used to calculate the position of each LED for each sample period. This data is downloaded over the communication channel 70 to an external computer for use with data visualization and analysis programs.

The microprocessor can also change the amount of drive current supplied to the LED, acting as an automatic gain control. Since the light intensity from a light source decreases by the inverse of the square of the distance from the source to the detector, and the light intensity of a LED is proportional to the drive current, the processor will control the LED drive current to maintain adequate light intensity at the sensor for high resolution readings.

The communications channel 70 may be a simple serial, USB or Ethernet. Faster communications channels are preferred because of the large volume of data collected during a crash test. With 12 LEDs, each monitored at a 10 kHz sample rate, the system stores 13 samples of 8 sensor outputs (3D case) every 100 microseconds. Therefore the system must store 1,040,000 samples of data every second. Each sample of each sensor current is converted into a 16 bit number, so the memory must be sized to handle 16 Mbits of data for each second of data acquired.

FIG. 12 also shows a trigger circuit 69. This external signal is used to mark the beginning of the event, or “Time-Zero” in industry terms. When the system is armed by the user via external command, it begins collecting data to a circular buffer in memory. When a Time-Zero signal is received it marks the current location in memory, and continues to record data for the remainder of the pre-defined test time. When the data is downloaded and processed by the external computer, each data sample is time stamped relative to Time-Zero. This allows the data to be compared with data from other measurement systems. During a typical vehicle crash test, 100 milliseconds of data is recorded pre-Time-Zero, and 900 milliseconds of data is recorded post-Time-Zero. A Time-Zero signal is usually created by specialized hardware and distributed to all data acquisition systems used for the test. The controller/DAS will have the capability to stream data over the communications channel when it is not collecting data at high speeds during a test. This data can be displayed by the external computer to verify that the LEDs are in the desired positions specified by the test requestor, the dummy ribs have not been deformed on a previous test, and they still meet the government mandated pre-test geometry, and the system is performing properly.

The discussions above have been focused on frontal impact dummies, but the same system can be used for side impact dummies as well. For side impact dummies, safety engineers have stated that they would like to record as many as 12 measurement points from each rib, or a total of 72 measurement points from the ribcage. Due to frequency response limitations of the PSD sensors, and the need to acquire data from each LED at a 10 kHz sample rate, a single system will not be able to monitor very many more than 12 LEDs. In this case multiple measurement systems can be used.

However, to prevent the light for a LED being driven by one measurement system from affecting the adjacent measurement system, narrow band color filters can be placed over the LEDs and sensors, with different color filters used for adjacent systems. For example, the top rib system may be limited to infrared light, the next rib system could use blue light, and the next could use red light, etc. This light wavelength modulation technique will allow multiple systems to be mounted near each other without any cross-talk between systems. Thus the number of measurement points may be greatly increased.

While this invention has been particularly shown and described with references to preferred embodiments thereof, it will be understood by those skilled in the art that various changes in form and details may be made therein without departing from the scope of the invention encompassed by the appended claims.

What is claimed is:

1. An anthropomorphic test device (ATD) comprising:
a light emitter, said light emitter being mounted on an ATD member; and
plural incident light angle detectors that receive light from the light emitter.

2. The anthropomorphic test device of claim 1, wherein data collected from the incident light angle detectors provides a measurement of ATD member deformation.

3. The anthropomorphic test device of claim 1, wherein the measurement of the ATD deformation is performed with the use of optical triangulation techniques.

4. The anthropomorphic test device of claim 3, wherein the ATD member is a rib.

5. The anthropomorphic test device of claim 1, wherein a measurement range of a pair of incident light angle detectors is defined by an overlapping field of view.

6. The anthropomorphic test device of claim 1, wherein no mechanical connections exist between the light emitter and the plural incident light angle detectors other than through the ATD member.

7. The anthropomorphic test device of claim 1, wherein the light emitter and the plural incident light angle detectors comprise narrow band color filters.

8. An anthropomorphic test device (ATD) comprising:
a light emitter; and
plural incident light detectors that receive light from the light emitter; and
a data processor that determines relative position of the light emitter and incident light detectors through a triangulation process.

9. An ATD as claimed in claim 8 wherein the incident light detectors are angle detectors.

10. A method of providing an anthropomorphic test device (ATD) measurement comprising steps of:
providing a light emitter, said light emitter being mounted on an ATD member;
receiving light from the light emitter with the use of plural incident light angle detectors;
collecting data from the incident light angle detectors; and
providing a measurement of ATD member deflection.

11. The method of claim 10, wherein the step of providing the measurement of the ATD member deflection further comprises:
calculating ATD member deflection with the use of optical triangulation techniques.

12. The method of claim 10, wherein the ATD member is a rib.

13. The method of claim 10, wherein no mechanical connections exist between the light emitter and the plural incident light angle detectors other than through the ATD member.

14. The method of claim 10, further comprising a step of:
preventing cross-talk of near-by measurement systems with the use of narrow band color filters.

15. A method of providing an anthropomorphic test device (ATD), said ATD comprising a plurality of light emitters and at least one sensor mounted on an ATD member, the method comprising steps of:
digitizing and storing, in memory, an output of the at least one sensor in the ATD; and
turning on, sequentially, only one of the plurality of light emitters while repeating the above step for a duration of a test.

16. The method of claim 15, further comprising the steps of:
processing data samples stored in memory to convert raw sensor readings to LED positions in engineering units;
transferring the data over a communication channel to an external computer, once the test is completed; and
storing the data samples in a data file used with data visualization and analysis programs.

17. A method of providing anthropomorphic test device (ATD) measurement comprising:
lighting means for providing a light emitter, said light emitter being mounted on an ATD member;
receiving means for receiving light from the light emitter;
collecting means for collecting data from plural incident light angle detectors; and
measurement means for proving a measurement of ATD member deflection.

18. The method of claim 17 further comprising:
filtering means for preventing cross-talk of near-by measurement systems.
